(19) United States
(12) Patent Application Publication
(10) Pub. No.: US 2005/0093502 A1
(43) Pub. Date: May 5, 2005

(54) Stage with isolated actuators for low vacuum environment

(75) Inventors: Alex Ka Tim Poon, San Ramon, CA (US); Leonard Wai-Fung Kho, San Francisco, CA (US)

Correspondence Address: RITTER, LANG & KAPLAN, 12930 SARATOGA AE. SUITE D1, SARATOGA, CA, 95070, US

(73) Assignee: NIKON CORPORATION, Tokyo (JP)

(21) Appl. No.: 10/698,198

(22) Filed: Oct. 31, 2003

(51) Int. Cl. G05B 11/18; B64C 17/06

(52) U.S. Cl. 318/592; 318/649

(57) ABSTRACT

Methods and apparatus for enabling a stage apparatus to scan an object within a vacuum environment while isolating actuators, cables, and hoses from the vacuum environment are disclosed. According to one aspect of the present invention, a stage apparatus includes a first stage and a first actuator. The first stage is effectively configured such that an interior space is defined substantially within the first stage. The first actuator is positioned within the interior space, and drives the first stage in a first direction.

### BACKGROUND OF THE INVENTION

1. Field of Invention

The present invention relates generally to semiconductor processing equipment. More particularly, the present invention relates to a stage assembly which is suitable for use in a vacuum environment and includes motors which are substantially out of contact with the vacuum environment.

2. Description of the Related Art

For precision instruments such as photolithography machines which are used in semiconductor processing, factors which affect the performance, e.g., accuracy, of the precision instrument generally must be dealt with and, insofar as possible, eliminated. When the performance of a precision instrument is adversely affected, as for example by contamination, products formed using the precision instrument may be improperly formed and, hence, function improperly. For example, if a vacuum environment in which a photolithography machine operates is contaminated, the vacuum level associated with the environment may be compromised, thereby affecting an overall photolithography process.

Lithography processes, e.g., photolithography processes, are integral to the fabrication of wafers and, hence, semiconductor chips. Systems used for lithography include optical lithography systems, electron beam projection systems, and extreme ultraviolet lithography (EUVL) systems. The development of EUVL systems is becoming more widespread, as the capabilities of EUVL systems generally exceed those of conventional optical lithography systems and electron beam projection systems.

In an EUVL system, beams of extreme ultraviolet (EUV) light are reflected off of a reflective reticle, which contains a circuit pattern, onto a semiconductor wafer. Reticle scanning stages are generally used to position a reticle over a wafer such that portions of the wafer may be exposed as appropriate for masking or etching. Patterns are generally resident on the reticle, which effectively serves as a mask or a negative for the wafer. When a reticle is positioned with respect to a wafer as desired, a beam of EUV light may be reflected off of the reticle on which a thin metal pattern is placed and effectively focused onto the wafer.

Many scanning stage devices include a coarse stage and a fine stage which cooperate to position an object such as a reticle or a wafer. Specifically, many high precision machines used in semiconductor fabrication use a coarse stage for relatively large motion and a fine stage for smaller, or more precise, motion. A coarse stage is used to coarsely position a wafer, for example, near a desired position, while a fine stage is used to finely tune the position of the wafer once the wafer is positioned near its desired position by the coarse stage.

FIG. 1 is a block diagram representation of a coarse stage and a fine stage which may be used as a part of an EUVL system. A coarse stage 112 and a fine stage 108, which is carried on coarse stage 112, are positioned within a vacuum chamber 104. Coarse stage 112 is coupled to a counter mass 116. A reticle (not shown) that is supported on fine stage 108 may be positioned such that a beam of EUV light may be reflected off of the reticle (not shown) onto a surface of a wafer (not shown).

In general, an EUVL system must operate in a relatively high vacuum environment, which may be expensive to maintain, as any gas leakage into the vacuum environment must be corrected as the gas leakage typically compromises the vacuum level. Since flexible hoses or cables which are associated with typical EUVL systems often outgas or leak within the vacuum environment, the use of such hoses and cables may compromise the vacuum level associated with the vacuum environment. Further, air bearings in an EUVL system may also leak. Maintaining the vacuum level in a vacuum environment such as a chamber to compensate for gas leakage and other contamination is often difficult or impractical.

As is the case with many scanning stages, the scanning stages used in an EUVL system are typically moved using motors such as linear motors. When it is necessary to service the motors, since the motors are positioned within a vacuum chamber, the vacuum chamber is generally opened to enable the motors to be accessed. Opening and closing, i.e., unsealing and resealing, the vacuum chamber is often a tedious process. The accessing of motors within a vacuum chamber exposes the vacuum chamber to contaminants and moisture, which may contaminate the surfaces of components within the vacuum chamber. The moisture within the vacuum chamber generally must be removed before the vacuum chamber may be used again, which increases the time associated with an overall pump down process used to create a vacuum within the vacuum chamber once the vacuum chamber is resealed.

Within a vacuum chamber, it is difficult to maintain an acceptable operational temperature, as motors used to move a reticle scanning stage often heat up during operation. When the temperature within the vacuum chamber is too high, the operation of sensors within the vacuum chamber may be compromised. Since there is no air available in the vacuum chamber during an EUVL process, the only cooling that is available within the vacuum chamber results from conduction and radiation. As such, maintaining an acceptable temperature within the vacuum chamber is often a difficult process.

Maintaining an acceptable vacuum level and an acceptable temperature within a vacuum chamber is important in order to ensure a high level of performance for an EUVL process. Ensuring that motors are properly serviced is also important, as the accuracy with which a wafer scanning stage may be moved is dependent upon the operation of the motors. Since maintaining a desired vacuum level, maintaining a desired temperature, and ensuring the proper operation of motors are crucial to an EUVL system, the ability to efficiently and relatively easily maintain a desired vacuum level, maintain a desired temperature, and ensure the proper operation of motors is important.

Therefore, what is needed is a method and an apparatus for enabling is a relatively easy to maintain EUVL system. That is, what is desired is an EUVL system which has motors that are relatively easy to service, and enables both a desired vacuum level and a desired temperature to be accurately and efficiently maintained.

### SUMMARY OF THE INVENTION

The present invention relates to a stage apparatus which scans an object in a vacuum environment while isolating actuators, cables, and hoses from the vacuum environment. According to one aspect of the present invention, a stage apparatus includes a first stage and a first actuator. The first stage is effectively configured such that an interior space is defined substantially within the first stage. The first actuator is positioned within the interior space, and drives the first stage in a first direction.

In one embodiment, the apparatus also includes a stage assembly that is supported by the first stage. The stage assembly includes a second stage and a second actuator that drives the second stage in a second direction. In such an embodiment, the apparatus may also include an interface plate that is coupled to the first stage and the second stage assembly such that the second stage assembly is supported by the first stage through the interface plate.

A stage assembly which includes a coarse stage with an associated actuator that may be isolated from a vacuum environment while a fine stage of the stage assembly is positioned within the vacuum environment enables the vacuum environment to be efficiently maintained without significant issues associated with heat that is generated by the actuator, or contamination that results from the servicing of the actuator. Further, since the actuator associated with the coarse stage is external to the vacuum environment, substantially any moving hoses or cables associated with the coarse stage are also external to the vacuum environment, thereby reducing the likelihood of gas leakage and outgassing within the vacuum environment. Hence, when the stage assembly is used in a system such as an extreme ultraviolet lithography (EUVL) system, the performance and the efficiency of the EUVL system may be improved.

According to another aspect of the present invention, an apparatus includes a vacuum chamber arrangement, a first stage assembly, a second stage assembly, and an interface plate. The vacuum chamber arrangement provides a vacuum environment such as a low vacuum environment. The first stage assembly includes a first stage and a first actuator that drives the first stage. The first stage defines an interior section, and the first actuator is positioned within the interior section such that the first actuator is substantially unexposed to the vacuum environment. The second stage assembly includes a second stage and an actuator arrangement that drives the second stage. The second stage is arranged within the vacuum chamber arrangement such that the second stage is exposed to the vacuum environment, while the interface plate couples the first stage assembly to the second stage assembly. In one embodiment, the first actuator is drives the first stage along a first axis and the second actuator drives the second stage along at least one of the first axis and a second axis.

These and other advantages of the present invention will become apparent upon reading the following detailed descriptions and studying the various figures of the drawings.

### BRIEF DESCRIPTION OF THE DRAWINGS

The invention may best be understood by reference to the following description taken in conjunction with the accompanying drawings in which:

FIG. 1 is a block diagram representation of a coarse stage and a fine stage which may be used as a part of an extreme ultraviolet lithography (EUVL) system.

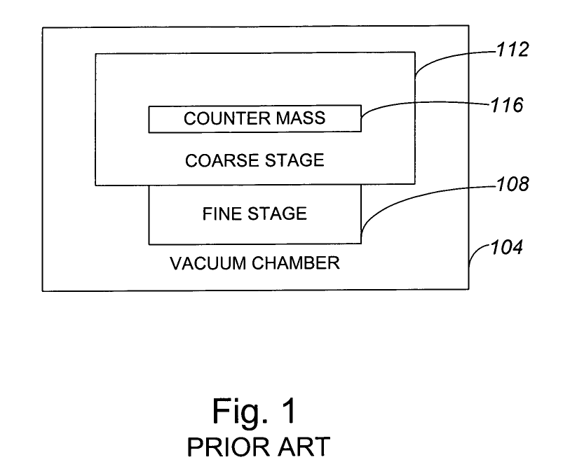

FIG. 2 is a block diagram representation of an EUVL system in accordance with an embodiment of the present invention.

FIG. 3 is a diagrammatic cross-sectional representation of an EUVL system which includes an actuator that is substantially isolated from a vacuum environment in accordance with an embodiment of the present invention.

FIGS. 4a and 4b are diagrammatic representations of a stage assembly in accordance with an embodiment of the present invention.

FIG. 5 is a diagrammatic cut-away representation of a stage assembly, i.e., stage assembly 400 of FIG. 4b, in accordance with an embodiment of the present invention.

FIG. 6 is a diagrammatic representation of a coarse stage and a stage interface plate, i.e., coarse stage 404 and stage interface plate 410 of FIG. 4b, in accordance with an embodiment of the present invention.

FIG. 7 is a diagrammatic exploded representation of a stage assembly, i.e., stage assembly 400 of FIG. 4b, in accordance with an embodiment of the present invention.

FIG. 8 is a diagrammatic representation of a counter mass, i.e., counter mass 406 of FIG. 7, in accordance with an embodiment of the present invention.

FIG. 9 is a diagrammatic representation of a photolithography apparatus in accordance with an embodiment of the present invention.

FIG. 10 is a process flow diagram which illustrates the steps associated with fabricating a semiconductor device in accordance with an embodiment of the present invention.

FIG. 11 is a process flow diagram which illustrates the steps associated with processing a wafer, i.e., step 1304 of FIG. 10, in accordance with an embodiment of the present invention.

### DETAILED DESCRIPTION OF THE EMBODIMENTS

The performance of extreme ultraviolet lithography (EUVL) system is often compromised when an acceptable vacuum level or an acceptable temperature within a vacuum chamber may not be maintained. Further, the performance of an EUVL system may also be compromised whenever contaminants enter the vacuum chamber, e.g., during the maintenance of motors within the vacuum chamber. Hence, the ability to efficiently and relatively easily maintain a desired vacuum level, maintain a desired temperature, and ensure the proper operation of motors associated with an EUVL system is critical.

A stage arrangement which is arranged to be positioned such that components of the stage, as for example hoses and actuators, are positioned substantially outside of a vacuum environment may improve the performance of an EUVL system while allowing for the EUVL system to be more readily maintained. Keeping hoses, e.g., moving hoses, substantially outside of a vacuum environment reduces the amount of contamination and outgassing within the vacuum environment, while maintaining actuators substantially outside of the vacuum environment enables the actuators to be serviced without affecting the vacuum environment, and relaxes cooling requirements associated with the operation of the motors. While hoses and actuators associated with a stage arrangement are maintained outside of a vacuum environment, as for example in a low vacuum environment, an object such as a reticle may be scanned within the vacuum environment.

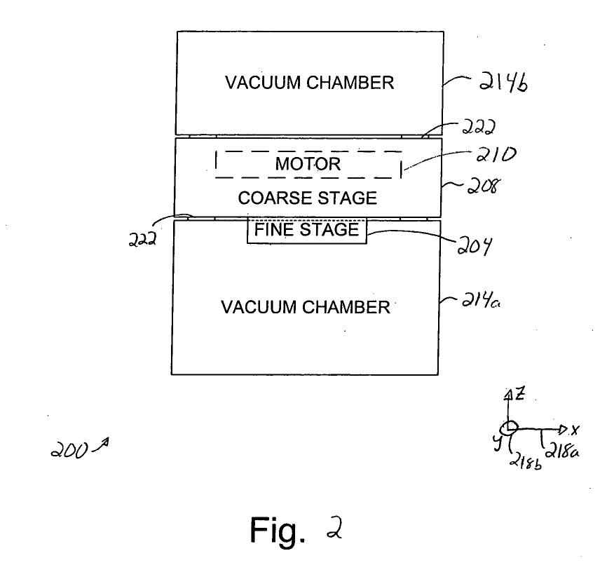

FIG. 2 is a block diagram representation of an EUVL system in accordance with an embodiment of the present invention. An EUVL system 200 includes a coarse stage 208 and a fine stage 204 which are arranged to scan a reticle (not shown) that is supported on fine stage 204. Fine stage 204 is positioned such that a reticle (not shown) supported thereon is scanned within a vacuum chamber arrangement 214. Coarse stage 208 is positioned substantially between sections 214a, 214b of vacuum chamber arrangement 214 such that a plurality of exterior surfaces of coarse stage 208 are effectively in contact with a vacuum environment within vacuum chamber arrangement 214 while interior surfaces of coarse stage 208 are substantially not in contact with the relatively high vacuum within the vacuum environment. In other words, an interior of coarse stage 208 is essentially not exposed to a vacuum environment, as for example a high vacuum environment, within vacuum chamber arrangement 214, and is, instead, exposed to the atmosphere, or a relatively low vacuum environment, surrounding vacuum chamber arrangement 214.

An actuator or motor 210 which allows coarse stage 208 to scan in either an x-direction 218a or a y-direction 218b is positioned such that motor 210 is essentially not exposed to the vacuum environment within vacuum chamber arrangement 214, i.e., motor 210 is substantially isolated from the vacuum environment within vacuum chamber arrangement 214. In one embodiment, an interior of coarse stage 208 is exposed to the atmosphere surrounding vacuum chamber arrangement 214 such that motor 210 is exposed to the atmosphere. When motor 210 is substantially external to the vacuum environment within vacuum chamber arrangement 214, maintenance of motor 210 may be performed without compromising the vacuum environment within vacuum chamber arrangement 214. In other words, it is generally unnecessary to open vacuum chamber arrangement 214 and, hence, expose the vacuum environment within vacuum chamber arrangement 214 to contaminants and moisture, in order to perform maintenance on motor 210.

Configuring coarse stage 208 such that motor 210 is external to vacuum chamber arrangement 214 enables motor 210 to be cooled using convection, in addition to or in lieu of conduction and radiation. When motor 210 may be cooled outside of vacuum chamber arrangement 214, air may be used to cool motor 210, thereby providing a relatively easy to implement and relatively inexpensive cooling process. As a result, motor 210 may have a higher elevated temperature when motor 210 is external to vacuum chamber arrangement 214 than when a motor which moves a coarse stage is internal to a vacuum chamber, since the motor may be more readily cooled, and heat generated by motor 210 is less likely to affect the temperature within vacuum chamber arrangement 214.

Additionally, since motor 210 is located outside of vacuum chamber arrangement 214, any cables and hoses which are coupled to motor 210 are also external to vacuum chamber arrangement. Such cables and hoses are typically flexible, as they often undergo some movement while motor 210 is in operation. As a result, any outgassing associated with such cables and hoses has substantially no effect on the vacuum environment within vacuum chamber arrangement 214. Since the outgassing associated with cables and hoses, especially cables and hoses formed from flexible materials such as rubber, that are coupled to motor 210 have substantially no effect on the vacuum environment within vacuum chamber arrangement 214, substantially any suitable material may be used to form such cables and hoses.

Air bearings 222 are used to enable motor 210 to scan coarse stage 208 substantially without friction along either x-axis 218a or y-axis 218b. Since coarse stage 208 is substantially external to vacuum chamber arrangement 214, leakage from air bearings 222 with a pump-out-grove design generally does not have a significant effect on the vacuum level within vacuum chamber arrangement 214. In addition, since hoses which supply fluid such as air to air bearings 222 are typically relatively flexible and may be located outside of vacuum chamber arrangement 214, the outgassing associated with such hoses may not have a significant effect on the vacuum level within vacuum chamber arrangement 214.

The cables and hoses associated coarse stage 208, respectively, generally move when coarse stage 208 scans, as mentioned above. Hence, by positioning such cables or hoses substantially outside of vacuum chamber arrangement 214, most of the cables or hoses that remain positioned within vacuum chamber arrangement 214 do not move, i.e., are generally relatively stationary. Cables or hoses which generally do not move may be formed from rigid materials which are less likely to outgas. As a result, substantially all fluid transfer inside of vacuum chamber arrangement 214 may be performed using rigid pipes.

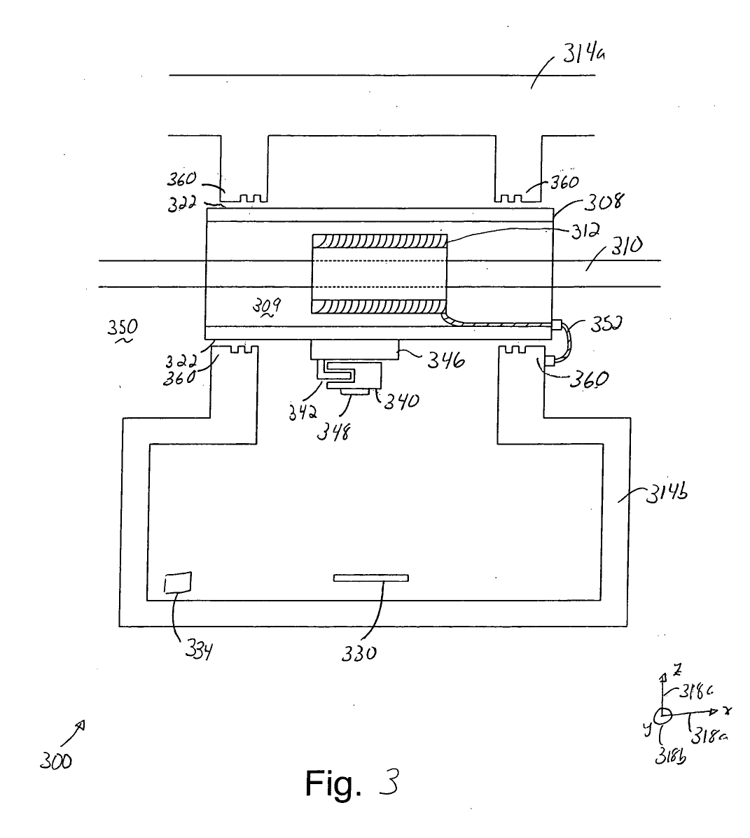

The design of an EUVL system which includes at least one motor, e.g., a motor which drives a scanning stage, that is external to a vacuum environment may vary widely. FIG. 3 is a diagrammatic cross-sectional representation of one EUVL system which includes a motor that is substantially isolated from a vacuum environment in accordance with an embodiment of the present invention. A system 300 includes a coarse stage 308, or a coarse stage box, which has an interior section 309 that is exposed to an environment 350 that substantially surrounds a vacuum chamber arrangement 314. Environment 350 is generally arranged at approximately atmospheric pressure, while the interior of vacuum chamber arrangement 314 is maintained at a vacuum level.

Interior section 309 is arranged to accommodate a coil assembly 312 which cooperates with a magnet track 310 to allow coarse stage 308 to translate in an x-direction 318a. Interior section 309 also accommodates a counter mass (not shown) associated with coarse stage 308. Cables, as for example cable 352, associated with coarse stage 308 and coil assembly 312 are arranged such that such cables pass through interior section 309. In other words, cables such as cable 352 that are associated with coarse stage 308, coil assembly 312, and air bearings 360 are arranged to come into contact with atmosphere 350, and not a vacuum environment within vacuum chamber arrangement 314. As a result, when such cables outgas or leak, the outgassing or leakage generally does not have a significant effect on the vacuum environment.

A fine stage 340 is coupled to coarse stage 308 through a stage interface plate 346. Fine stage 340 is arranged to carry a reticle 348. In one embodiment, an illumination source 334 is arranged to provide a beam of EUV light which reflects off of reticle 348 onto a wafer 330 that is being processed. Coarse stage 308 allows reticle 348 to be scanned relatively coarsely, while fine stage 340 enables reticle 348 to be scanned relatively finely. Within system 300, reticle 348 may have a relatively long travel direction with respect to x-axis 318a, and a relatively short travel direction with respect to a y-axis 318b. Hence, coarse stage 308 may be arranged to move substantially only along x-axis 318a, while fine stage 340 is arranged to be carried by coarse stage 308 along x-axis 318a and to scan along y-axis 318b using a motor 342. It should be appreciated, however, that additional motors may be coupled to fine stage 340 to allow additional movement of fine stage 340, e.g., a motor (not shown) may be coupled to fine stage 340 to allow fine stage 340 to translate along a z-axis 318c and motors (not shown) may be coupled to fine stage 340 to allow rotational motion about x-axis 318a and y-axis 318b.

In one embodiment, as for example when fine stage 340 is arranged to have either three or six degrees of freedom, fine stage 340 may be preloaded. The mechanism (not showed) that is used to provide a preload force on fine stage 340 may vary widely. Suitable preload mechanisms may include, but are not limited to, a spring suspension system that is coupled to coarse stage 308 and a vacuum preload.

Vacuum chamber arrangement 314 includes a first vacuum chamber portion 314a and a second vacuum chamber portion 314b. Air bearings 360, which are a part of vacuum chamber arrangement 314 are arranged to cooperate with air bearing surfaces 322 of coarse stage 308 to allow for coarse stage 308 to move along x-axis 318a substantially without friction.

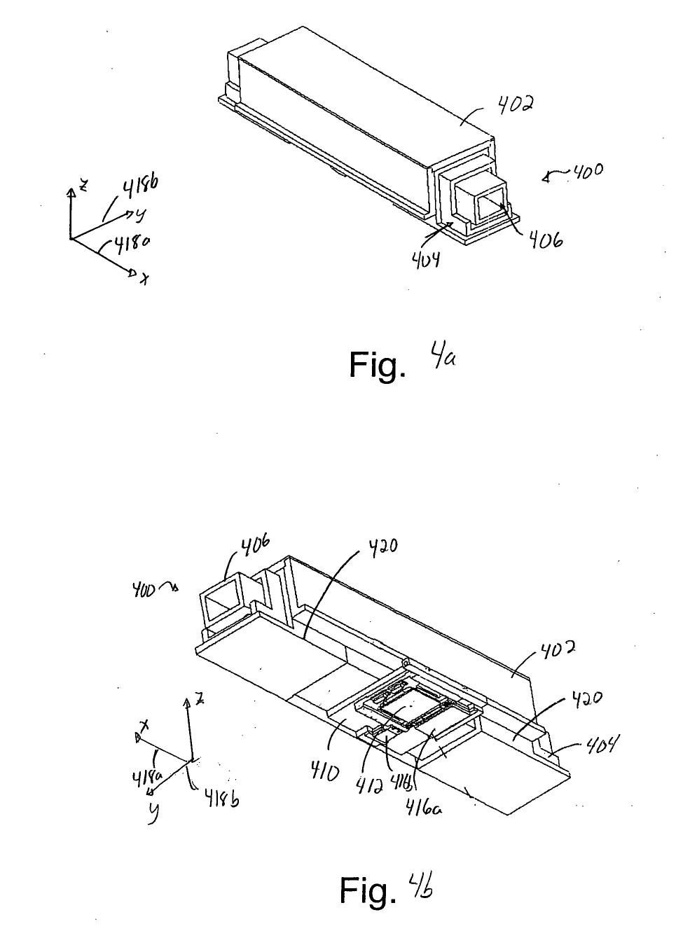

The configuration of a coarse stage assembly which includes coarse stage 308 and the configuration of a fine stage assembly which includes fine stage 340 may vary widely. With reference to FIGS. 4a and 4b, one embodiment of an overall stage assembly which includes a coarse stage and a fine stage will be described in accordance with an embodiment of the present invention. A stage assembly 400 is positioned such that stage assembly 400 is at least partially surrounded by a sleeve 402 which may be coupled to a body, i.e., a body of a vacuum chamber arrangement such as vacuum chamber arrangement 314 of FIG. 3.

Stage assembly 400 includes a coarse stage 404 which is arranged to scan along an x-axis 418a and a counter mass 406. As shown in FIG. 4b, coarse stage 404 is effectively coupled to a fine stage 412 through a stage interface plate 410. An actuator 416a is arranged substantially on stage interface plate 410 to allow fine stage 412 to undergo fine movements move along a y-axis 418b. In the described embodiment, fine stage 412 is also coupled to stage interface plate 410 through an actuator 416a which allows fine stage 412 to undergo fine movements along x-axis 418a. When actuator 416a is present, actuator 416a may effectively finely position fine stage 412 along x-axis 418a after scanning of coarse stage 404 essentially coarsely positions fine stage 412 relative to x-axis 418a. Air bearing assemblies 420, which are vacuum isolated, interface with an air bearing surface (not shown) of coarse stage 404 to facilitate the translational movement of coarse stage 404 along x-axis 418a while effectively reducing any leakage of gas into a vacuum environment when stage assembly 400 is used within an EUVL system.

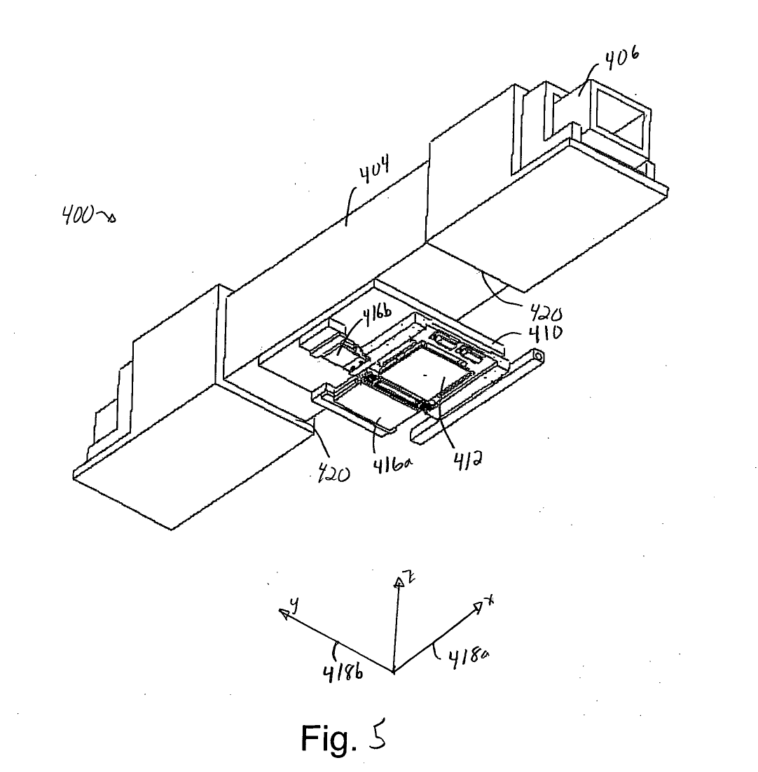

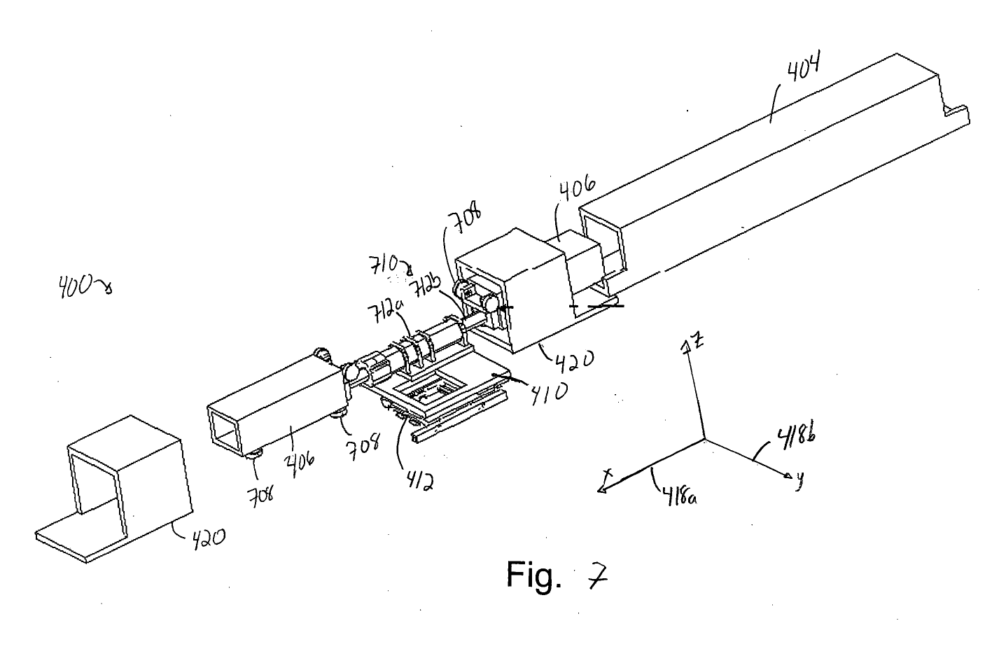

FIG. 5 is a diagrammatic representation of a stage assembly, e.g., stage assembly 400 of FIGS. 4a and 4b, as shown without a sleeve, e.g., sleeve 402 of FIGS. 4a and 4b, in accordance with an embodiment of the present invention. In general, when coarse stage 404 scans in x-direction 418a, since stage interface plate 410 is coupled to both coarse stage 404 and fine stage 412, fine stage 412 also scans in x-direction 418a. An actuator (not shown) which enables coarse stage 404 to scan is positioned within coarse stage 404, as will be described below with reference to FIG. 7.

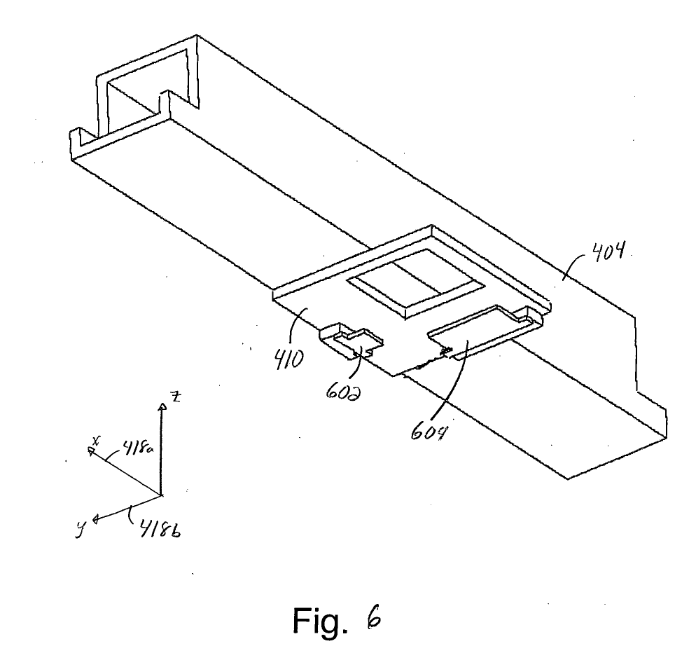

Coarse stage 404 is shown in FIG. 6, along with stage interface plate 410. Stage interface plate 410 is fixed or otherwise coupled to a bottom surface of coarse stage 404. The bottom surface of coarse stage 404 is arranged as an air bearing surface. Stage interface plate 410 supports a magnet coil 604 which is a part of actuator 416a, as shown in FIG. 4b, and a magnet coil 602 which is a part of actuator 416b, as shown in FIG. 4b.

Within coarse stage 404, components which include an actuator and a counter mass, or a bearing box, are housed. With reference to FIG. 7, the components contained within coarse stage 404 will be described. FIG. 7 is an exploded representation of stage assembly 400 of FIG. 4a in accordance with an embodiment of the present invention. Coarse stage 404, which is effectively a hollow box, is arranged to substantially house an actuator 710 which, in the described embodiment, includes a coil 712a and a magnet track 712b. Since actuator 710 is housed within coarse stage 404, actuator 710 is exposed to an atmosphere external to a vacuum chamber arrangement, rather than to a vacuum environment within a vacuum chamber arrangement. Hence, when actuator 710 generates heat during operation, the generated heat does not have a significant effect on the vacuum environment. In addition, since substantially any cables (not shown) which are associated with actuator 710 are also external to the vacuum chamber arrangement, any outgassing of such cables also does not have a significant effect on the vacuum environment.

Coil 712a is arranged to scan over magnet track 712b, and is further arranged to be coupled to an interior surface of coarse stage 404. Magnet track 712b is coupled to counter mass 406 which effectively includes two bearing boxes on which guide bearings 708 are mounted. Guide bearings 708 facilitate the movement of coarse stage 404 relative to counter mass 406, which is arranged to substantially cancel out reaction forces associated with actuator 710, when actuator 710 causes coarse stage 404 to scan along x-axis 418a. It should be appreciated that since guide bearings 708 are exposed to the atmosphere around a vacuum chamber arrangement, substantially any cables or hoses (not shown) which are coupled to guide bearings 708, e.g., air supply hoses, are also external to the vacuum chamber arrangement. Thus, any leakage or outgassing of such hoses generally has an insignificant effect on the vacuum environment within the vacuum chamber arrangement.

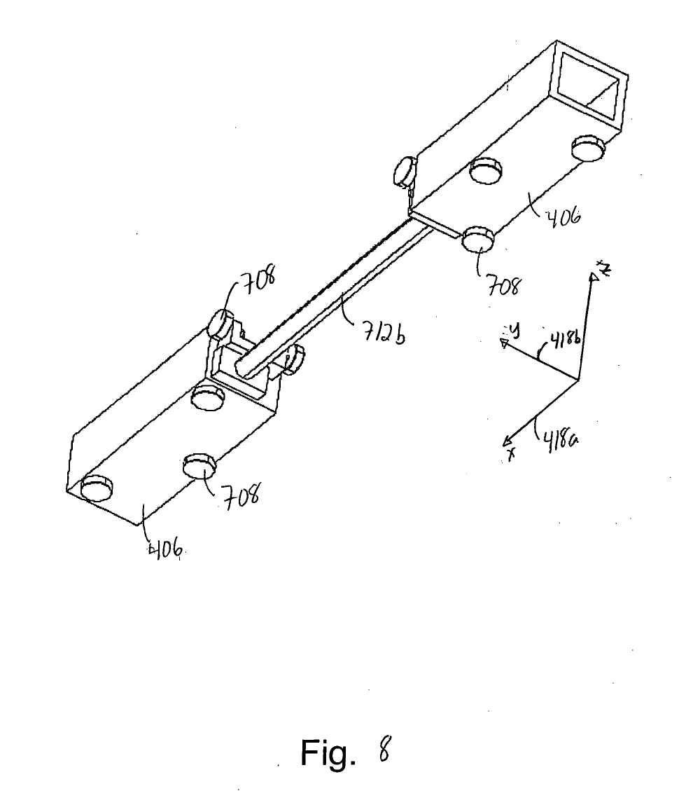

As shown in more detail in FIG. 8, magnet track 712b is effectively a shaft which is coupled to halves, or bearing boxes, of counter mass 406. Counter mass 406 is arranged such that there are guide bearings 708 on three sides of counter mass 406. As shown, counter mass 406 may include five guide bearings 708 on each half. However, that the number of guide bearings 708 associated with counter mass 406, as well as the location of guide bearings 708, may vary widely. It should be appreciated that although counter mass 406 may be coupled to a trim motor, as for example a trim motor that is coupled between counter mass 406 and an exterior of a vacuum chamber, a trim motor has not been shown for ease of illustration.

When counter mass 406 is arranged to be positioned substantially within coarse stage 404, as shown in FIG. 4a, coarse stage 404 may be driven through an approximate center of gravity associated with stage assembly 400. Hence, disturbances associated with driving coarse stage 404 may be substantially minimized. Counter mass 406 may be shaped to effectively match the driving forces associated with coarse stage 404.

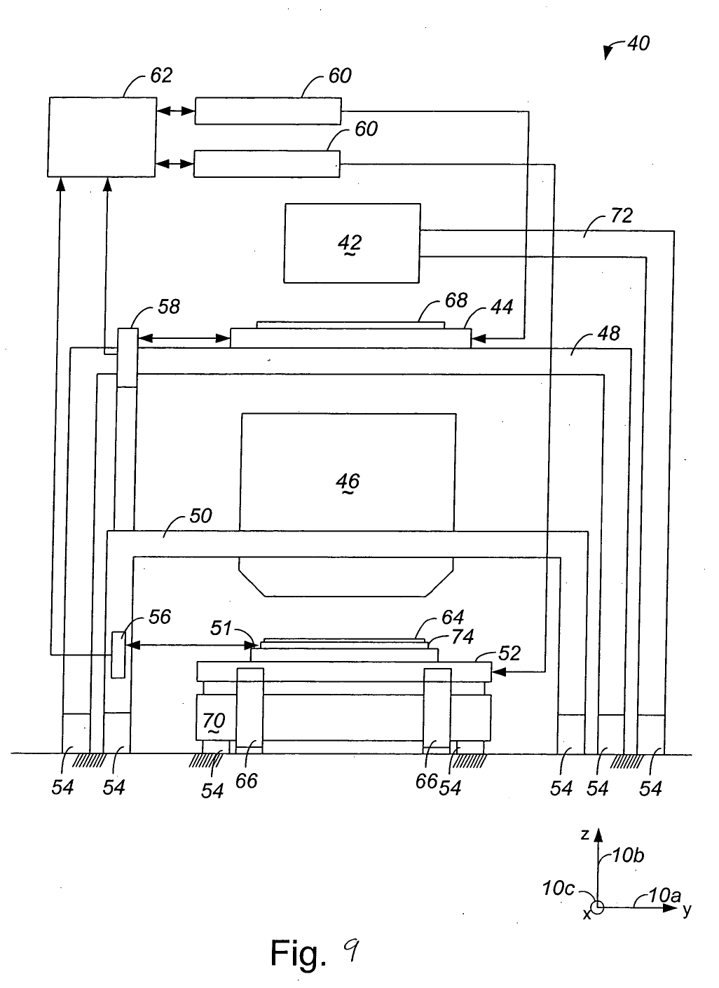

With reference to FIG. 9, a photolithography apparatus which may include a stage with isolated actuators will be described in accordance with an embodiment of the present invention. It should be appreciated that although a stage with isolated actuators has been described as being suitable for use as a part of an EUVL system, such a stage may generally be used as a part of substantially any suitable photolithography apparatus. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an EI-core actuator, e.g., an EI-core actuator with a top coil and a bottom coil which are substantially independently controlled. The planar motor which drives wafer positioning stage 52 generally uses an electromagnetic force generated by magnets and corresponding armature coils arranged in two dimensions. A wafer 64 is held in place on a wafer holder or chuck 74 which is coupled to wafer table 51. Wafer positioning stage 52 is arranged to move in multiple degrees of freedom, e.g., between three to six degrees of freedom, under the control of a control unit 60 and a system controller 62. In one embodiment, wafer positioning stage 52 may include a plurality of actuators and have a configuration as described above. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In the described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, which may provide a beam of EUV light that may be reflected off of a reticle. In one embodiment, illumination system 42 may be arranged to project a radiant energy, e.g., light, through a mask pattern on a reticle 68 that is supported by and scanned using a reticle stage 44 which includes a coarse stage and a fine stage. It should be appreciated that for such an embodiment, photolithography apparatus 40 may be a part of a system other than an EUVL system. In general, a stage with isolated actuators may be used as a part of substantially any suitable photolithography apparatus, and is not limited to being used as a part of an EUVL system. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 mm), a KrF excimer laser (248 nm), an ArF excimer laser (193 nm), and an F₂-type laser (157 nm). Alternatively, illumination system 42 may also use charged particle beams such as x-ray and electron beams. For instance, in the case where an electron beam is used, thermionic emission type lanthanum hexaboride (LaB₆) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser is used, glass materials such as quartz and fluorite that transmit far ultra-violet rays is preferably used. When either an F₂-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

Further, in photolithography systems, when linear motors (see U.S. Pat. No. 5,623,853 or 5,528,118, which are each incorporated herein by reference in their entireties) are used in a wafer stage or a reticle stage, the linear motors may be either an air levitation type that employs air bearings or a magnetic levitation type that uses Lorentz forces or reactance forces. Additionally, the stage may also move along a guide, or may be a guideless type stage which uses no guide.

Alternatively, a wafer stage or a reticle stage may be driven by a planar motor which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect performance of an overall photolithography system. Reaction forces generated by the wafer (substrate) stage motion may be mechanically released to the floor or ground by use of a frame member as described above, as well as in U.S. Pat. No. 5,528,118 and published Japanese Patent Application Disclosure No. 8-166475. Additionally, reaction forces generated by the reticle (mask) stage motion may be mechanically released to the floor (ground) by use of a frame member as described in U.S. Pat. No. 5,874,820 and published Japanese Patent Application Disclosure No. 8-330224, which are each incorporated herein by reference in their entireties.

Isolaters such as isolators 54 may generally be associated with an active vibration isolation system (AVIS). An AVIS generally controls vibrations associated with forces 112, i.e., vibrational forces, which are experienced by a stage assembly or, more generally, by a photolithography machine such as photolithography apparatus 40 which includes a stage assembly.

A photolithography system according to the above-described embodiments, e.g., a photolithography apparatus which may include one or more dual force actuators, may be built by assembling various subsystems in such a manner that prescribed mechanical accuracy, electrical accuracy, and optical accuracy are maintained. In order to maintain the various accuracies, prior to and following assembly, substantially every optical system may be adjusted to achieve its optical accuracy. Similarly, substantially every mechanical system and substantially every electrical system may be adjusted to achieve their respective desired mechanical and electrical accuracies. The process of assembling each subsystem into a photolithography system includes, but is not limited to, developing mechanical interfaces, electrical circuit wiring connections, and air pressure plumbing connections between each subsystem. There is also a process where each subsystem is assembled prior to assembling a photolithography system from the various subsystems. Once a photolithography system is assembled using the various subsystems, an overall adjustment is generally performed to ensure that substantially every desired accuracy is maintained within the overall photolithography system. Additionally, it may be desirable to manufacture an exposure system in a clean room where the temperature and humidity are controlled.

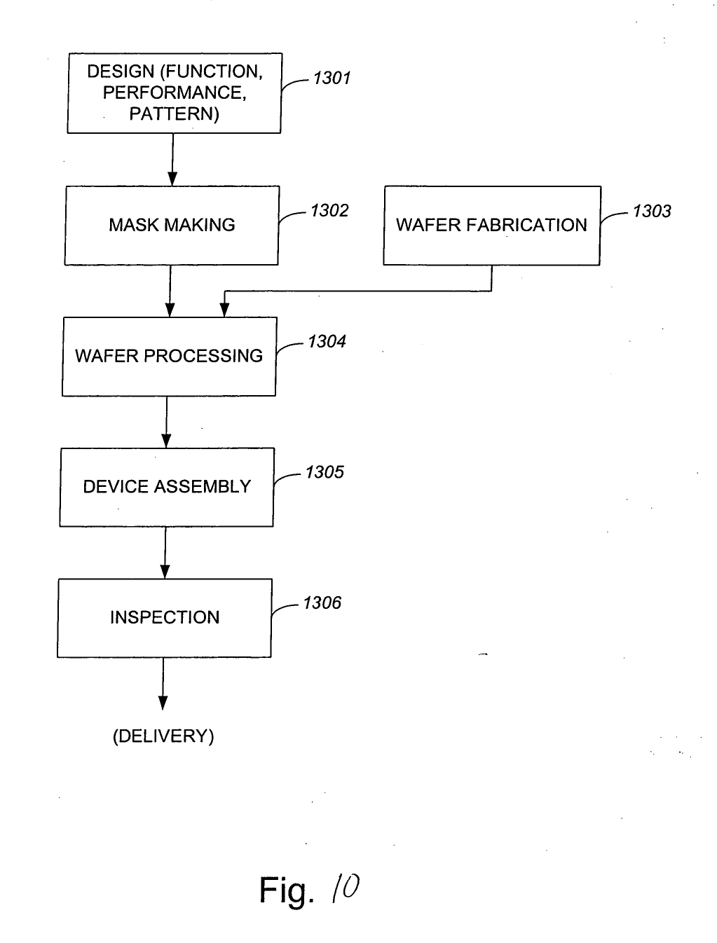

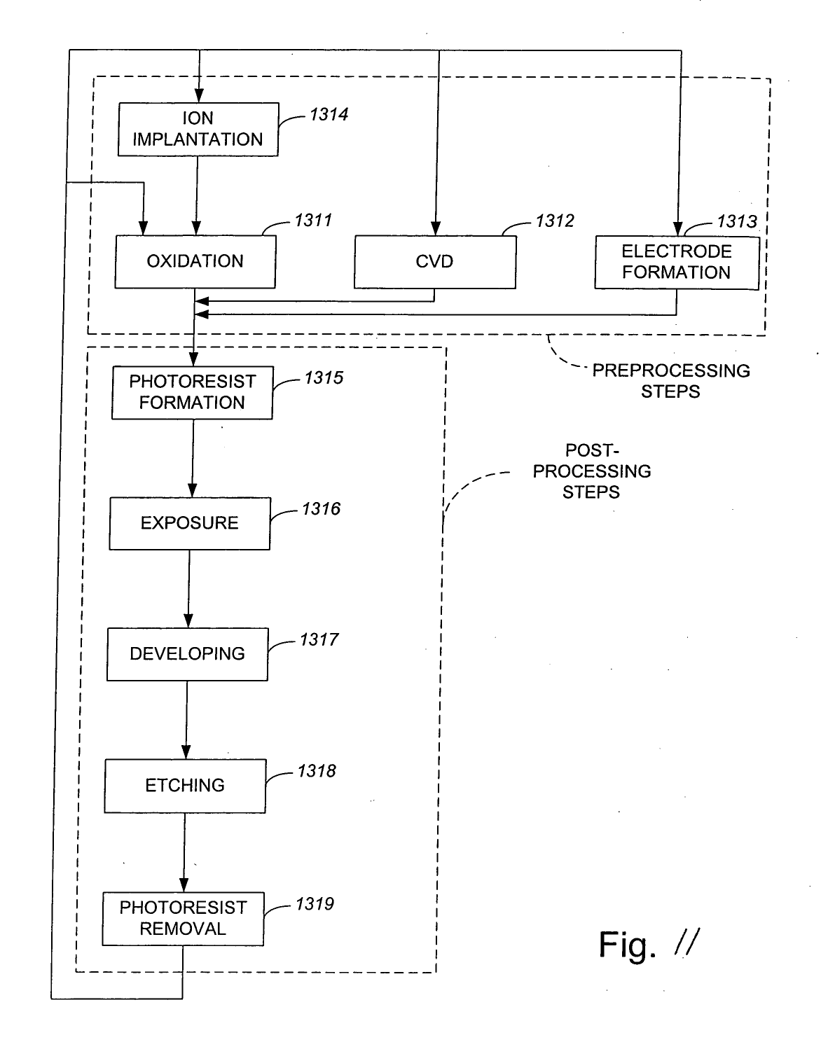

Further, semiconductor devices may be fabricated using systems described above, as will be discussed with reference to FIG. 10. The process begins at step 1301 in which the function and performance characteristics of a semiconductor device are designed or otherwise determined. Next, in step 1302, a reticle (mask) in which has a pattern is designed based upon the design of the semiconductor device. It should be appreciated that in a parallel step 1303, a wafer is made from a silicon material. The mask pattern designed in step 1302 is exposed onto the wafer fabricated in step 1303 in step 1304 by a photolithography system. One process of exposing a mask pattern onto a wafer will be described below with respect to FIG. 11. In step 1305, the semiconductor device is assembled. The assembly of the semiconductor device generally includes, but is not limited to, wafer dicing processes, bonding processes, and packaging processes. Finally, the completed device is inspected in step 1306.

FIG. 11 is a process flow diagram which illustrates the steps associated with wafer processing in the case of fabricating semiconductor devices in accordance with an embodiment of the present invention. In step 1311, the surface of a wafer is oxidized. Then, in step 1312 which is a chemical vapor deposition (CVD) step, an insulation film may be formed on the wafer surface. Once the insulation film is formed, in step 1313, electrodes are formed on the wafer by vapor deposition. Then, ions may be implanted in the wafer using substantially any suitable method in step 1314. As will be appreciated by those skilled in the art, steps 1311-1314 are generally considered to be preprocessing steps for wafers during wafer processing. Further, it should be understood that selections made in each step, e.g., the concentration of various chemicals to use in forming an insulation film in step 1312, may be made based upon processing requirements.

At each stage of wafer processing, when preprocessing steps have been completed, post-processing steps may be implemented. During post-processing, initially, in step 1315, photoresist is applied to a wafer. Then, in step 1316, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1317. Once the exposed wafer is developed, parts other than residual photoresist, e.g., the exposed material surface, may be removed by etching. Finally, in step 1319, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, while a stage arrangement which substantially isolates actuators and moving cables associated with a coarse stage from a vacuum environment has been described as being suitable for use as a part of an EUVL system, such a stage arrangement may be used for substantially any suitable application, e.g., any suitable application that requires the use of a vacuum. In other words, a stage arrangement as described above is not limited to being used as a part of an EUVL system, and may generally be used as a part of a variety of different systems including, but not limited to, systems which operate using a vacuum environment.

A stage assembly with isolated actuators has been shown as being substantially “box-like” in shape. Such a shape of a stage assembly, which allows a counter mass and an actuator to be nestled within a coarse stage, is relatively easy to manufacture, and facilitates the matching of driving forces associated with the stage assembly. That is, the box-like shape of a stage assembly enables a coarse stage in the stage assembly to be efficiently driven through a center of gravity associated with the coarse stage. It should be appreciated, however, that the stage assembly may have substantially any suitable shape. Other suitable shapes may include, but are not limited to, pipe-like shapes.

The use of a counter mass within a coarse stage has been described as being suitable for substantially canceling out reaction forces associated with an actuator which drives the coarse stage. In some embodiments, a counter mass may not be used. When a counter mass is not used, then a magnet track associated with the actuator may be mounted to an external wall of a vacuum chamber arrangement without departing from the spirit or the scope of the present invention.

A coarse stage has generally been described as having a single translational degree of freedom, while a fine stage has been described as having one or two translational degrees of freedom. While a stage assembly, as described above, is particularly suitable for use in a system where translation along one axis, i.e., the axis along which the coarse stage is driven, is relatively large while translation along another axis, i.e., an axis that is perpendicular to the axis along which the coarse stage is driven, is relatively small, such a stage assembly may be used in systems in which translation along more than one axis is relatively large. For example, an additional coarse stage actuator may be added to a stage assembly when the stage assembly is to have relatively large translational motion relative to two axes.

In general, a stage assembly has been described as including both a coarse stage and a fine stage. It should be appreciated, however, that a stage assembly which includes a coarse stage with isolated actuators, e.g., a coarse stage actuator and a trim motor for a counter mass associated with the coarse stage, may not necessarily include a fine stage. That is, a single stage with isolated actuators may be included in a stage assembly without departing from the spirit or the scope of the present invention. Therefore, the present examples are to be considered as illustrative and not restrictive, and the invention is not to be limited to the details given herein, but may be modified within the scope of the appended claims.

1. A stage apparatus comprising:
a first stage, the first stage being arranged to define an interior space;
a first actuator, the first actuator being positioned substantially within the interior space, the first actuator further being arranged to drive the first stage in a first direction; and
an air bearing arrangement, the air bearing arrangement being arranged to enable the first stage to be driven in the first direction substantially without friction.

2. A stage apparatus comprising:
a first stage, the first stage being arranged to define an interior space;
a first actuator, the first actuator being positioned substantially within the interior space, the first actuator further being arranged to drive the first stage in a first direction; and
a first counter mass, the first counter mass being coupled to the first actuator, wherein the first counter mass is positioned substantially within the interior space.

3. The stage apparatus of claim 2 wherein the first counter mass includes at least one guide bearing, the guide bearing being arranged to facilitate movement of the first stage relative to the first counter mass when the first actuator drives the first stage in the first direction.

4. The stage apparatus of claim 2 wherein the first actuator includes a coil and a magnet track, the magnet track being supported by the first counter mass, the coil being supported by the first stage.

5. The stage apparatus of claim 1 wherein the first actuator is arranged to drive the first stage in the first direction through a center of gravity associated with the first stage.

6. The stage apparatus of claim 1 further including:
a second stage assembly, the second stage assembly being supported by the first stage, the second stage assembly including a second stage and a second actuator, the second actuator being arranged to drive the second stage in a second direction.

7. The stage apparatus of claim 6 further including:
an interface plate, the interface plate being coupled to the first stage and the second stage assembly such that the second stage assembly is supported by the first stage through the interface plate.

8. The stage apparatus of claim 1 wherein the first stage is a coarse stage and the second stage is a fine stage, the fine stage being arranged to support an object to be scanned.

9. An exposure apparatus comprising the stage apparatus of claim 1.

10. A device manufactured with the exposure apparatus of claim 9.

11. A wafer on which an image has been formed by the exposure apparatus of claim 9.

12. A stage device comprising:
a first stage assembly, the first stage assembly including a first stage and a first actuator arranged to drive the first stage, the first stage assembly further including an air bearing arrangement arranged to enable the first actuator to drive the first stage substantially without friction, the first stage being arranged to define an interior space therein, wherein the first actuator is arranged within the interior space; and
a second stage assembly, the second stage assembly being coupled to the first stage assembly, the second stage assembly including a second stage and a second actuator arranged to drive the second stage.

13. A stage device comprising:
a first stage assembly, the first stage assembly including a first stage and a first actuator arranged to drive the first stage, the first stage being arranged to define an interior space therein, wherein the first actuator is arranged within the interior space, wherein the first stage assembly further includes a counter mass arrangement, the counter mass arrangement being arranged within the interior space and coupled to the first actuator; and
a second stage assembly, the second stage assembly being coupled to the first stage assembly, the second stage assembly including a second stage and a second actuator arranged to drive the second stage.

14. The stage device of claim 12 wherein the first actuator is arranged to drive the first stage along a first axis and the second actuator is arranged to drive the second stage along a second axis.

15. The stage device of claim 12 wherein the first stage is a coarse stage and the second stage is a fine stage, the fine stage being arranged to support an object to be scanned.

16. A stage device comprising:
a first stage assembly, the first stage assembly including a first stage and a first actuator arranged to drive the first stage, the first stage being arranged to define an interior space therein, wherein the first actuator is arranged within the interior space; and
a second stage assembly, the second stage assembly being coupled to the first stage assembly, the second stage assembly including a second stage and a second actuator arranged to drive the second stage, wherein the second stage is arranged within a vacuum environment, and wherein the first actuator is arranged within a non-vacuum environment.

17. The stage device of claim 16 further including:
an air bearing assembly, the air bearing assembly being substantially vacuum isolated, wherein the air bearing assembly is arranged to cooperate with the first stage assembly to substantially reduce leakage into the vacuum environment when the first stage is driven by the first actuator.

18. An exposure apparatus comprising the stage device of claim 12.

19. The exposure apparatus of claim 18 wherein the exposure apparatus is part of an extreme ultraviolet lithography system.

20. A device manufactured with the exposure apparatus of claim 18.

21. A wafer on which an image has been formed by the exposure apparatus of claim 18, wherein the second stage is arranged to support a reticle that is used to form the image on the wafer.

22. An apparatus comprising:
a vacuum chamber arrangement, the vacuum chamber arrangement being arranged to provide a vacuum environment;
a first stage assembly, the first stage assembly including a first stage and a first actuator arranged to drive the first stage, the first stage having an interior section, the first actuator being arranged within the interior section, wherein the first actuator is substantially unexposed to the vacuum environment;
a second stage assembly, the second stage assembly including a second stage and a second actuator arranged to drive the second stage, wherein the second stage is arranged within the vacuum chamber arrangement such that the second stage is exposed to the vacuum environment; and
an interface plate, the interface plate being arranged to couple the first stage assembly to the second stage assembly.

23. The apparatus of claim 22 wherein the first actuator is arranged to drive the first stage along a first axis and the second actuator is arranged to drive the second stage along at least one of the first axis and a second axis.

24. The apparatus of claim 22 wherein the first stage assembly further includes a counter mass arrangement, the counter mass arrangement being arranged within the interior section.

25. The apparatus of claim 24 wherein the first actuator includes a shaft and a coil assembly, the shaft being coupled to the counter mass, the coil assembly being coupled to the first stage.

26. The apparatus of claim 22 further including an air bearing assembly, the air bearing assembly being arranged to reduce leakage into the vacuum environment when the first stage is driven by the first actuator.

27. The apparatus of claim 22 wherein the apparatus is an extreme ultraviolet lithography apparatus and the second stage is arranged to carry a reticle.

28. An exposure apparatus comprising the apparatus of claim 22.

29. A device manufactured with the exposure apparatus of claim 28.

30. A wafer on which an image has been formed by the exposure apparatus of claim 28.
